(19) United States
(12) Patent Application Publication
(10) Pub. No.: US 2016/0212101 A1
(43) Pub. Date: Jul. 21, 2016

(54) PROTECTING CONTENT INTEGRITY

(71) Applicant: Instart Logic, Inc., Palo Alto, CA (US)

(72) Inventors: Mohammad H. Reshadi, Sunnyvale, CA (US); Rajaram Gaunker, Santa Clara, CA (US); Hariharan Kolam, Palo Alto, CA (US); Raghu Batta Venkat, Palo Alto, CA (US)

(21) Appl. No.: 15/079,396

(22) Filed: Mar. 24, 2016

Related U.S. Application Data
(63) Continuation-in-part of application No. 14/206,344, filed on Mar. 12, 2014.
(60) Provisional application No. 62/222,116, filed on Sep. 22, 2015.
(60) Provisional application No. 62/279,468, filed on Jan. 15, 2016.

(51) Int. Cl. H04L 29/06; G06F 21/64; H04L 9/32

(52) U.S. Cl. CPC H04L 63/0414; H04L 63/0428; H04L 9/3236; G06F 21/64

(57) ABSTRACT

A request for a resource of web content is received. It is determined whether the request identifies the resource using a transformed identifier that has been generated by transforming an original identifier of the resource. In the event it is determined that the request identifies the resource using the transformed identifier, the transformed identifier is translated back to the original identifier of the resource. The resource is obtained using the original identifier of the resource. The obtained resource is provided as a response to the request for the resource of web content.

### CROSS REFERENCE TO OTHER APPLICATIONS

This application is a continuation in part of co-pending U.S. patent application Ser. No. 14/206,344 entitled APPLICATION LAYER LOAD BALANCER filed Mar. 12, 2014, which is incorporated herein by reference for all purposes.

This application claims priority to U.S. Provisional Patent Application No. 62/222,116 entitled DISABLING AD-BLOCKERS filed Sep. 22, 2015 which is incorporated herein by reference for all purposes.

This application claims priority to U.S. Provisional Patent Application No. 62/279,468 entitled PROTECTING CONTENT INTEGRITY filed Jan. 15, 2016 which is incorporated herein by reference for all purposes.

### BACKGROUND OF THE INVENTION

Modern Internet browsers allow third-party plugins and other program code that can access and modify Internet content requested to be displayed by the Internet browser. For example, a browser plugin may add, remove, or modify web content as desired. However, in many instances, the modification to web content may take place without the knowledge or explicit authorization of a user or a publisher of the web content. For example, a browser plugin may add an unauthorized third-party advertisement content to a webpage without the consent of a publisher of the webpage or a viewer of the webpage. In another example, a content censuring filter may have removed content automatically from a webpage without the explicit consent of the publisher of the webpage or the viewer of the webpage. This breach in integrity of Internet content such as the webpage without consent of a content publisher often undermines the functionality and intent of original content as originally intended by the publisher to be displayed to a user. Therefore, there exists a need for a better way to protect the integrity of Internet content such that it is rendered as intended by a publisher of the Internet content.

### BRIEF DESCRIPTION OF THE DRAWINGS

Various embodiments of the invention are disclosed in the following detailed description and the accompanying drawings.

FIG. 1 is a block diagram illustrating an embodiment of a web browser accessing webpages and other information through a network.

FIG. 2 is a diagram illustrating an embodiment of webpage 200 described by an HTML file.

FIG. 3 is a diagram illustrating an embodiment of a DOM tree 300.

FIG. 4 is a block diagram illustrating an embodiment of an optimized content delivery environment.

FIG. 5 is a flowchart illustrating an embodiment of a process for generating a modified document object model.

FIG. 6 is a flowchart illustrating an embodiment of a process for providing a transformed version of a web content.

FIG. 7 is a flowchart illustrating an embodiment of a process for dynamically transforming a resource identifier.

FIG. 8 is a flowchart illustrating an embodiment of a process for providing a resource in response to a request.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Protecting content is disclosed. For example, integrity of web content is protected in a manner that reduces the likelihood the web content is altered prior to display to an end user. In some embodiments, content from a content source is intercepted. For example, rather than receiving content from an origin server, content is delivered from an intermediary server that obtains the content from the origin server for delivery to clients that request the content. Resource names/identifiers to be transformed are identified within the content. For example, identifiers of one or more webpage resources such as scripts, web programs, images, and other resources are identifiers to be transformed. In some embodiments, in order to prevent third-party content modifiers (e.g., content modifier/blocker provided by a third-party to modify/block content that was originally intended by an origin publisher to be rendered to a user) from recognizing resources to replace or block, resource names/identifiers are obfuscated so that these third-party content modifiers cannot recognize resources of the web content such as a webpage. The transformed resource names are delivered to a client having a process that is configured to operate on the encrypted resource names. For example, a resource filename is a part of a Uniform Resource Identifier (URI) and the resource filename has been transformed and cannot be directly utilized to obtain the resource because the file with the transformed filename does not exist. The client may include a virtualization component (e.g., script) that is configured to provide the request for the resource to an intermediary server that will translate the transformed resource name to its original resource name, obtain the resource using the original resource name, and provide the resource to the client in response to the request for the resource with the translated resource name.

Although certain resource names may be transformed prior to delivery to a client in a web content, transformation of certain resource names may not be desirable or possible prior to delivery to the client. For example, dynamically generated requests for resources (e.g., requests generated using scripts) may be difficult to modify to utilize a transformed resource name/identifier. Additionally, certain functionality such as cookies and scripts may require that the client utilize the original resource name/identifier rather than a transformed resource name/identifier. In some embodiments, resource names of web content are transformed/obfuscated directly by a client. For example, a webpage includes a virtualization component (e.g., script) that when executed by a client (e.g., by a web browser) translates identifiers of external resources of the web content (e.g., external resources of the webpage) when the external resources are to be requested. For example, in order to prevent undesired third-party content modifiers from recognizing and blocking/replacing certain network requests, the resource identifiers (e.g., part of URI) of the request are obfuscated by transforming the resource identifier. By allowing the client itself to transform the resource identifier, resource identifiers of dynamic requests are able to be dynamically obfuscated (e.g., dynamically transformed when being requested via a network) and a client is allowed to execute a version of web content with the original resource name.

Performing resource name transformation may negatively impact computer performance. For example, introducing an extra layer of processing to obfuscate a resource name adds to the overall processing required for a user to render content. In some embodiments, rather than performing resource name transformation by default, resource name transformation is only performed when it is detected that content integrity has been breached. For example, existence/operation/installation of a third-party program/plug-in that is modifying, adding, or blocking at least a portion of content resources is detected and resource identifier transformation/obfuscation is only performed upon detection of the third-party content modifier (e.g., content blocker). The detection may be performed using an included program/script of web content that detects whether certain content components known to be targeted have been modified, added, or blocked.

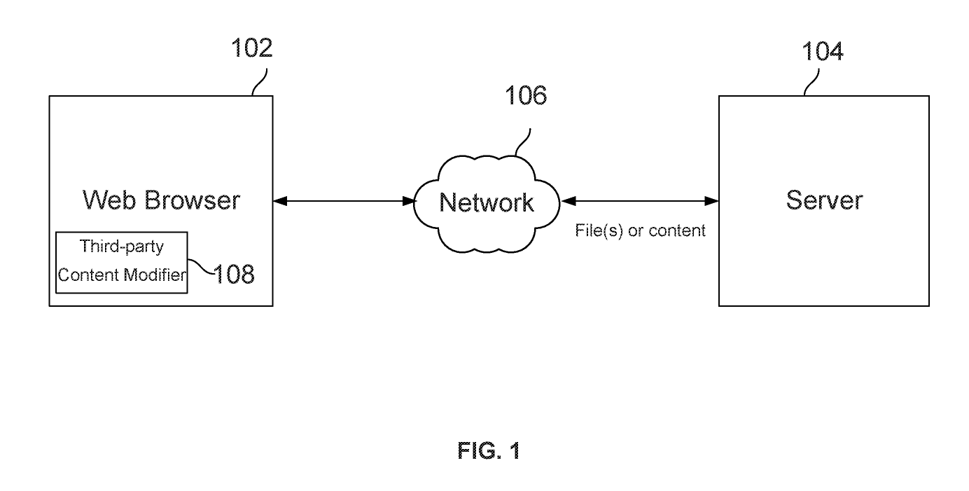

FIG. 1 is a block diagram illustrating an embodiment of a web browser accessing webpages and other information through a network. As shown in FIG. 1, a web browser 102 is connected to a server 104 (e.g., an edge server) through a network 106. Network 106 may be any combination of public or private networks, including intranets, local area networks (LANs), wide area networks (WANs), radio access networks (RANs), Wi-Fi networks, the Internet, and the like. Web browser 102 may run on different types of devices, including laptop computers, desktop computers, tablet computers, smartphones, and other mobile devices.

A webpage accessed by web browser 102 may be described by different markup languages, including Hypertext Markup Language (HTML), Extensible Markup Language (XML), and the like. The webpage may also be described by different scripting languages, including JavaScript, JavaScript Object Notation (JSON), and the like. The webpage may be described by other custom languages as well. HTML is used hereinafter as an example of the various languages for describing webpages. Note that the examples of HTML are selected for illustration purposes only; accordingly, the present application is not limited to these specific examples.

Web browser 102 includes third-party content modifier 108 that alters content received from server 104 to be provided to a user. For example, third-party content modifier 108 may add, remove, modify, or block content to be obtained and rendered from server 104. Examples of third-party content modifier 108 include a web browser plugin, a program, a script, and any other code that is able to alter content of web browser 102. For example, a user may have unknowingly installed a web browser plugin that will modify advertisements (e.g., replace original advertisements with other third-party advertisements) of content received from server 104 or another content server. When a network request for resources of a webpage (e.g., external image/script resources of a webpage to be obtained) is made by web browser 102, third-party content modifier 108 may monitor requests and block/modify select requests based on which portion/resource of the web content/page that third-party content modifier 108 desires to modify. In some embodiments, if third-party content modifier 108 is unable to identify which content component/resource is being requested, third-party content modifier 108 is unable to selectively block/modify requests to modify content to be provided to a user.

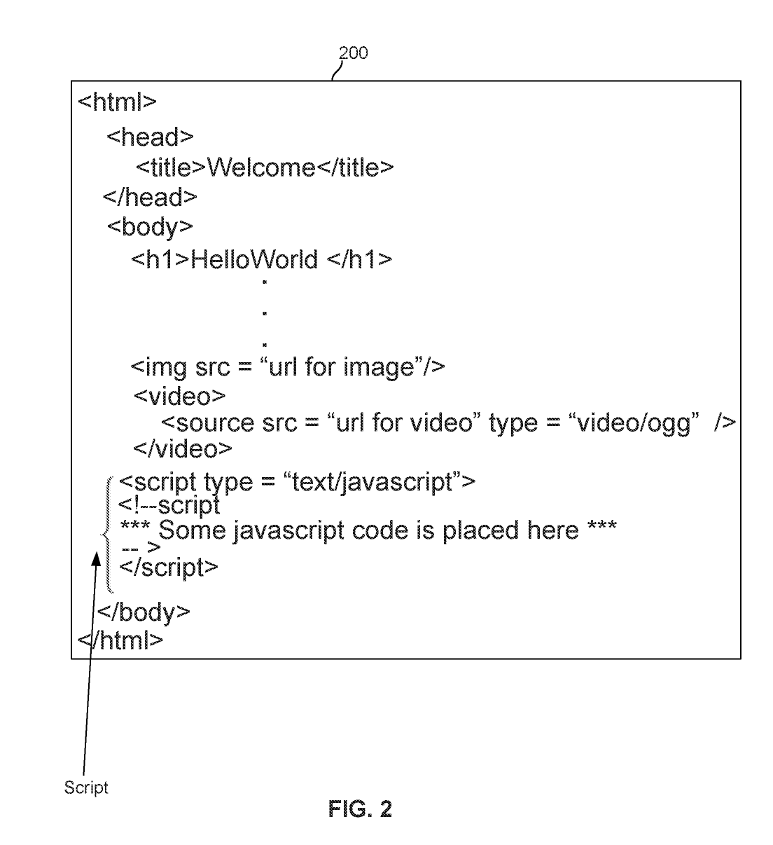

FIG. 2 is a diagram illustrating an embodiment of webpage 200 described by an HTML file. To display the webpage, web browser 102 sends a Hypertext Transfer Protocol (HTTP) request message to server 104 requesting the HTML webpage file. After server 104 locates the requested HTML webpage file, server 104 returns the requested HTML webpage file in an HTTP response message to web browser 102. As web browser 102 begins to render the webpage on a screen, web browser 102 parses the received webpage file and builds a data structure to represent the various components and resources of the webpage in a local memory.

The Document Object Model (DOM) is a standardized model supported by different web browsers, e.g., Internet Explorer, Firefox, and Google Chrome, to represent the various components of a webpage. The DOM is a cross-platform and language-independent convention for representing and interacting with objects in HTML documents, as well as XHTML and XML documents. Objects in a DOM tree may be addressed and manipulated using methods on the objects. The public interface of a DOM is specified in its application programming interfaces (APIs).

The DOM standard includes different levels. DOM core level 0 and level 1 are the core standards supported by all web browsers, while DOM levels 2 and above are extensions to DOM core level 0 and level 1, which can be optionally supported by different web browsers. DOM core level 0 and level 1 define a minimal set of objects and interfaces for accessing and manipulating document objects. It provides a complete model for an entire HTML document, including the means to change any portion of the document.

The DOM standard represents documents as a hierarchy of node objects, called a DOM tree. Some types of nodes may have child nodes of various types, and others are leaf nodes that cannot have any objects below them in the document structure hierarchy.

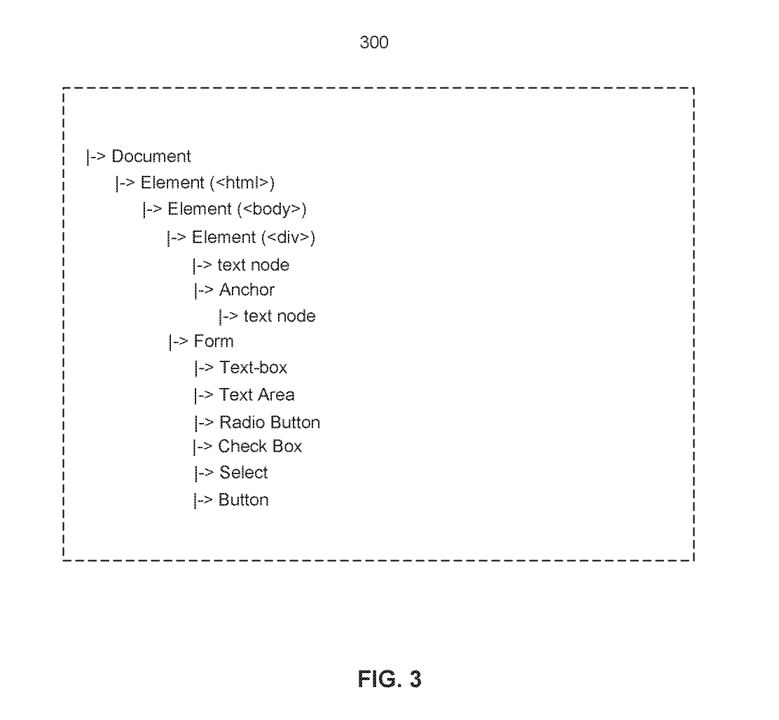

FIG. 3 is a diagram illustrating an embodiment of a DOM tree 300. As shown in FIG. 3, the topmost node, or root, of DOM tree 300 is the document object. A document object represents an entire HTML (or XML) document, and it provides the primary access to the document's data. The element object represents an element in the HTML document. Other types of nodes in the DOM tree may include text nodes, anchors, text-boxes, text areas, radio buttons, check boxes, selects, buttons, and the like.

With continued reference to FIG. 2, when web browser 102 renders webpage 200 on a screen, web browser 102 parses the received HTML webpage file and builds a DOM tree to represent the various components and resources of webpage 200 in a local memory. For example, when the image tag (shown as <img src=“url for image”/> in FIG. 2) is parsed by web browser 102, the image is represented as an image object, and the image object is inserted into the DOM tree accordingly.

After the webpage file is parsed and the corresponding DOM tree is created, the entire DOM tree can be traversed to retrieve any dependent resources (e.g., images, audio clips, or videos) indicated by any of the nodes in the DOM tree via a network. For example, the image object corresponding to the image tag in webpage 200 redirects web browser 102 to fetch an image file from a uniform resource locator (URL). Accordingly, web browser 102 sends a request via a network, requesting the image resource to be downloaded. There are two ways a request may be issued: statically, in which case it is the browser which manipulates the DOM; or dynamically, in which case the DOM manipulation is done by Javascript. In response to the request, the requested dependent resource is sent to web browser 102 via a network.

For example, if the nodes of the DOM tree include N different links and/or URLs, N separate GET requests (e.g., N separate HTTP GET requests) are sent via a network requesting the dependent resources to be sent to web browser 102. In response, N separate GET responses (e.g., N separate HTTP GET responses) are sent to web browser 102, delivering the dependent resources to web browser 102.

The round trip time or network response time for a GET request to arrive at an edge server and for its corresponding GET response to arrive at web browser 102 is dependent on the latency of the network, which is different for different types of networks. The network may be any combination of different types of public or private networks, including intranets, local area networks (LANs), wide area networks (WANs), radio access networks (RANs), Wi-Fi networks, the Internet, and the like. Therefore, the latency associated with the network may vary depending on its network type(s).

Some networks have relatively lower network latency. For example, the network latency associated with WANs or Wi-Fi networks is relatively low, e.g., on the order of 10 milliseconds. Suppose the number of links and/or URLs included in the DOM tree, N, is equal to twenty. The total network latency associated with receiving the dependent resources associated with the twenty links and/or URLs from the edge server, then, is approximately 200 milliseconds. To improve network performance, present day browsers have become more efficient in reusing connections to the same server, such that typically less than 20% of the connections may be fresh connections.

Some networks have relatively higher network latency. For example, the network latency associated with a 3^{rd} generation mobile telecommunications (3G) network is relatively high, e.g., on the order of 100 milliseconds. In this instance, the total network latency associated with receiving the dependent resources associated with the twenty links and/or URLs from the edge server is then on the order of two seconds.

Since the network latency associated with different types of networks varies widely, and web browser 102 needs to receive the dependent resources associated with the links and URLs before web browser 102 can complete the rendering of webpage 200, the startup wait time experienced by the end-user of the browsing session may be insignificant in low-latency networks, such as Wi-Fi networks, but unacceptably long for an end-user in higher-latency networks, such as 3G networks. Therefore, improved techniques for delivering information corresponding to a webpage is often also desirable.

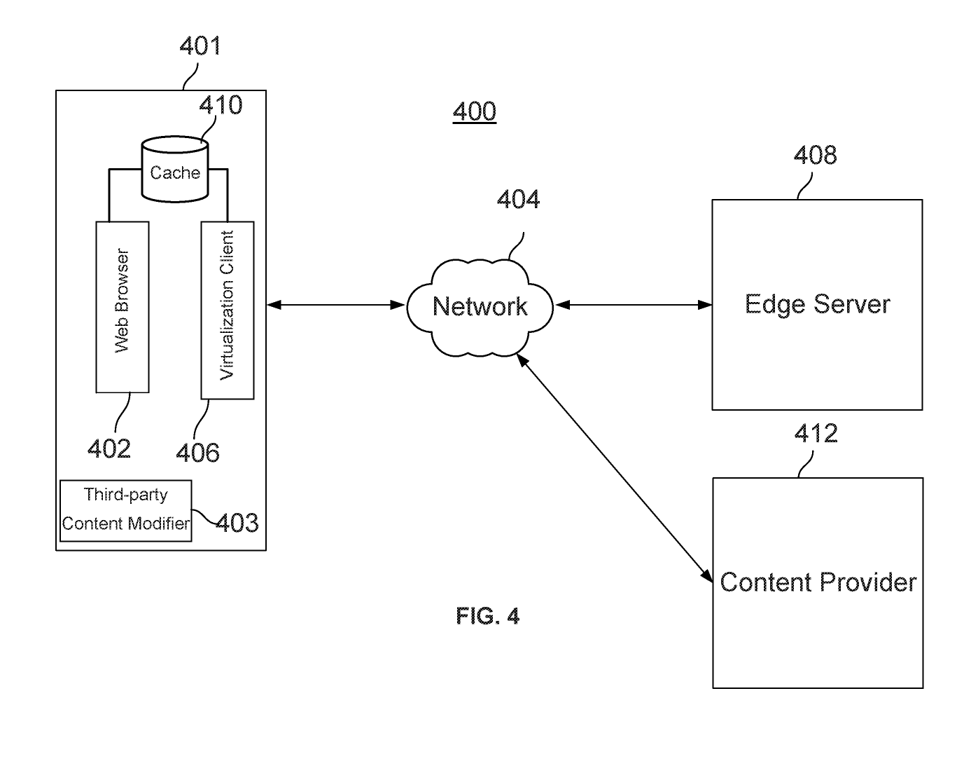

FIG. 4 is a block diagram illustrating an embodiment of an optimized content delivery environment. Client-server system 400 may be utilized to modify and/or virtualize a DOM of a web browser. Virtualization of a DOM of a web browser may allow the client-server system to take control of the DOM for different kinds of optimizations, while keeping the virtualization transparent to the web browser. One type of optimization enabled by virtualization is obfuscation of web content resource identifiers/names to hide the identity of the resources to prevent third-party content modifiers (e.g., modifier 108 of FIG. 1) from blocking/modifying the resources.

Client device 401 includes web browser 402, virtualization client 406, and cache 410. For example, an end-user may utilize client device 401 to access desired network/Internet content. Examples of client device 401 include a desktop computer, a laptop computer, a personal computer, a mobile device, a tablet computer, a smartphone, a wearable computer, and any other computing device. Client device 401 includes third-party content modifier 403 (e.g., modifier 108 of FIG. 1) that may add, remove, modify, and/or block content/resources to be provided by content provider 412 or another content provider. Examples of the third-party content modifier include a web browser plugin (e.g., plugin of web browser 402), a program, a script, and any other code that is able to alter content to be provided to a user via client device 401.

One or more of the following may be included in network 404: a direct or indirect physical communication connection, mobile communication network, Internet, intranet, Local Area Network, Wide Area Network, Storage Area Network, a wireless network, a cellular network, PTSN, and any other form of connecting two or more systems, communication devices, components, or storage devices together. Although example instances of components have been shown to simplify the diagram, additional instances of any of the components shown in FIG. 4 may exist. Components not shown in FIG. 4 may also exist.

A web browser 402 accesses webpages and other information through a network 404. When web browser 402 sends network messages onto network 404 that are related to the downloading of webpages or other information and resources, the messages may be (1) intercepted and processed by virtualization client 406 (e.g., prior to a third-party content modifier), (2) directly received and then processed by edge server 408, or (3) provided directly to a content provider such as content provider 412. In some embodiments, when web browser 402 requests a webpage, the request is provided to edge server 408 and/or origin content provider 412. In some embodiments, the web browser is provided a modified webpage file of the original webpage that has been processed to transform/obfuscate identifiers of one or more resources of the webpage. For example, at least a portion of names and/or URIs of images, scripts, multimedia content, program code, etc. is tranformed/encrypted in the HTML file of the webpage by edge server 408 prior to being delivered to client 401.

In some embodiments, rather than providing the originally requested HTML file of the original requested webpage, the web browser is provided an alternative webpage file of the original webpage that includes virtualization client 406. In some embodiments, although certain resource identifiers of the webpage may have been already transformed prior to delivery to web browser 402, certain resource identifiers may not have been transformed from their original identifier. For example, dynamically referenced resource identifiers of scripts may not have been transformed. In some embodiments, web browser 402 receives an original version of a requested webpage and its resource identifiers have not been transformed prior to delivery. In some embodiments, when an external resource of the webpage is requested, virtualization client 406 transforms an identifier of the resource to obfuscate the identity of the external resource to prevent third-party content modifier 403 from detecting the identity of the external resource.

In some embodiments, rather than providing the full HTML file of the original requested webpage, the web browser is provided an alternative webpage file of the original webpage that includes virtualization client 406 but not the complete contents of the requested webpage (e.g., HTML file) that would be provided in a traditional response. When web browser 402 attempts to render the alternative webpage, virtualization client 406 is executed. In some embodiments, rather than requesting a resource of a webpage to be rendered directly from its original content source identified by an original webpage, the request is proxied and/or rerouted via an intermediary such as edge server 408. For example, if translated/encrypted resource identifiers are utilized by client 401, the request for a resource using a transformed/encrypted resource identifier to the original content source (e.g., content provider 412) may fail because the original content source does not recognize the transformed/encrypted resource identifier. By routing the request via edge server 408, edge server 408 translates the transformed resource identifier to its original identifier and requests the requested resource from the content source (e.g., send request to provider 412) using the original identifier. Once edger server 408 receives the resource, the resource is provided to the client in response to the request for the resource provided using the transformed resource identifier. If edge server 408 had cached the requested resource, edge server 408 may provide the cached version in response to the request provided using the transformed resource identifier.

In some embodiments, virtualization client 406 initiates a different request for the actual contents of the desired webpage and receives the original desired webpage. This webpage may be modified by the virtualization client 406 as desired before rendering the desired webpage using web browser 402. Thus, by utilizing the alternative webpage that utilizes virtualization client 406 to fetch and modify the resources of the webpage, the resources of the webpage are able to be renamed or otherwise modified before the desired webpage is rendered by web browser 402. In some embodiments, a modified document object model structure that is different from the document object model structure corresponding to the received desired webpage is created using virtualization client 406.

In some embodiments, webpages or other information and resources related to the webpages that are sent to web browser 402 may be intercepted, filtered, processed, or provided by vitalization client 406 or edge server 408 (e.g., content from content provider 412 for web browser 402 is routed via virtualization client 406 and/or edge server 408). In addition, method API calls by web browser 402 or any JavaScript or other script/program code to manipulate the objects in a DOM tree may be intercepted, processed, or modified by virtualization client 406. Virtualization client 406 may also manipulate the DOM tree by making the appropriate method API calls to the DOM tree. In some embodiments, virtualization client 406 and edge server 408 together create a virtualization engine for the DOM of web browser 402. The virtualization engine may access and manipulate a DOM tree, including the creation, deletion, or update of nodes within the DOM tree.

In various embodiments, modifying the original webpage by creating a modified document object model structure different from the document object model structure corresponding to (e.g., specified by) the received desired webpage may be applicable to different types of optimizations. In some embodiments, content redirection may be achieved by replacing a location address of a webpage resource with another location address that is able to provide the resource more efficiently. In some embodiments, optimized delivery of information over a network by segmentation and reprioritization of downloaded information is achieved. For example, the delivery of the information (e.g., the order in which the information is delivered or the granularity of the information delivered) and the actual content of the delivered information corresponding to any nodes of the DOM tree structure may be altered, thereby speeding up the rendering of a webpage without compromising the end-user's experience.

In some embodiments, the virtualization and/or modification of the DOM structure is transparent (e.g., invisible) to web browser 402. In some embodiments, the virtualization and/or modification of the DOM structure is also transparent to the end-users. For example, the end-users are not required to install any plugins. In some embodiments, the virtualization of the DOM structure is also transparent to the content publishers, without requiring the content publishers to change any codes.

In some embodiments, virtualization client 406 may be injected into web browser 402 based on standards-based (e.g., HTML, JavaScript, ActionScript, etc.) procedures. For example, after edge server 408 receives a request from web browser 402 requesting an HTML webpage file, server 408 injects virtualization client 406 into an alternative HTML webpage file of the requested HTML file, and then sends the response back to web browser 402. In some embodiments, virtualization client 406 may be injected into web browser 402 by a content provider directly. For example, web browser 402 requests an HTML webpage file directly from content provider 412 and content provider 412 provides an alternative webpage file with code of injected virtualization client 406. Content provider 412 may be a content producer of the provided content. In some embodiments, virtualization client 406 may be injected by adding JavaScript client code in the head section of an alternative HTML webpage file. Examples of content provider 412 include an origin server and a node/server of a content delivery network.

In some embodiments, when an alternative webpage file is received by web browser 402, the received content includes a data mapping of one or more content locations (e.g., uniform resource identifier (URI)/uniform resource locator (URL), IP address, etc.) to corresponding translated content locations. For example, a table of translating initial URIs to translated URIs is received along with the corresponding initial webpage content and code of client 406. In some embodiments, virtualization client 406 requests the data mapping along with a request for contents of an original requested webpage. The table may be used to replace a URI of a resource (e.g., image, video, other referenced content, etc.) of the desired webpage to a different translated URI before the external resource is requested via network 404. In some embodiments, the original desired webpage content references one or more resources and the resources are to be obtained via network 404 (e.g., from edge server 408 or content provider 412). Virtualization client 406 may modify a target location address of a resource of the webpage with another location address using the received mapping data. For example, one or more initial content location addresses of resources specified by the intercepted request may be replaced with other location addresses that are (1) associated with a more efficient/faster server that is able to provide the resource and/or (2) associated with different resource(s) or different version(s) of the resource(s) that are to replace initially referenced resource(s). In some embodiments, a location address that references content provider 412 is to be replaced with a different location address that references edge server 408 instead. In some embodiments, in a response to a resource request, edge server 408 may provide an update to a data structure mapping of one or more initial target location addresses of resource requests to one or more corresponding translated target location addresses, provided along with the requested content. The update to the data structure may be specific to a webpage of the resource request.

In some embodiments, browser cache 410 stores content that can be utilized by browser 402 to render web content instead of obtaining the content via network 404. For example, if the desired content of browser 402 is locally stored in a cache of the machine running browser 402, it would be faster to obtain the content locally rather than via a network request. However, dynamic content is often difficult to cache at browser cache 410. For example, if content is known to change, the content may not be cached in cache 410 and/or associated with a very short time-to-live (TTL) time when the cached dynamic content may be utilized. In some embodiments, dynamic content is able to be cached at browser cache 410 by enabling identification of whether the most current version of the dynamic content is cached. For example, a current version identifier of requested web content is received from edge server 408 and virtualization client 406 requests the most current version as indicated by the version identifier to be utilized. In the event the current version of the web content has not been cached, the current version of the web content is requested via a network. For example, a previous cached version of the web content is not utilized if it is not the latest indicated version. In the event the current version of the web content has been cached, the cached web content is utilized. In some embodiments, virtualization client 406 requests the most current version, as indicated by the version identifier, to be utilized by modifying a request of content (e.g., add query string, modify URI, etc.) to specify the most current version as the requested version. In some embodiments, content cached by cache 410 may be stored using a transformed identifier and reduces a need to route a resource request via edge server 408 to translate the transformed identifier to its original identifier to request and proxy the original resource from content provider 412.

If browser cache 410 and/or a cache of edge server 408 is caching an old version of content that has been since modified/updated, the old version may be deleted and entire contents of the new version requested and received via content via network 404. However when dynamic content is updated, often only a portion of the dynamic content has been modified from a previous version of the dynamic content. In some embodiments, when edge server 408 receives an indication that web content has been updated, it determines the difference between the updated web content and a previous version of the web content. In some embodiments, when web browser 402 and/or virtualization client 406 requests the latest version of a previously cached content, the determined difference is provided by edge server 408 and virtualization client 406 produces the updated web content using the difference and a previous version of the updated web content. For example, rather than sending the entire updated web content, a smaller sized difference update is sent to allow virtualization client 406 to patch/update the previous version to generate the latest updated version.

In some embodiments, one or more resources of a webpage/web content desired to be rendered by browser 402 are preloaded in browser cache 410 prior to the original code of the webpage/web content requesting the resource. Thus when the preloaded content is needed/requested by the original code, the requested content is already in the cache for immediate use rather than requiring a request to be made via a network for the requested content. In some embodiments, by preloading cache 410, a third-party content modifier is unable to intercept and block/modify requests for resources. In some embodiments, one or more resources of a webpage/web content to be preloaded are requested in an optimized order. Obtaining resources in a requested order of the original code of the webpage/web content may not be optimal for rendering the webpage/web content as soon as possible. Often a web browser is limited by a limitation on a maximum number of concurrent connections to a single server. For example, web browser 402 is allowed to maintain up to four connections per server and when web browser 402 needs to obtain more than four resources from a single server, the additional requests for resources from the server must be queued. However, the ordering in which resources are requested affects the total amount of time required to obtain all the resources. In some embodiments, the ordering in which resources should be obtained is reordered and optimized based at least in part on one or more of the following: an order of resources requested in the webpage, an observed order of resources placed in a DOM, sizes of the resources, a maximum number of possible concurrent connections, a parameter/setting of the browser being utilized, a type of browser being utilized, visual importance of the resources, utilization frequencies of the resources, and other properties/information about the resources.

In some embodiments, using the virtualization client 406, optimized delivery of information over a network by segmentation and reprioritization of downloaded information may be achieved. Note that the delivery of different information to web browser 402 may be determined by the type of information. For example, dependent resources such as images, audio clips, and videos may be delivered using different techniques that are optimized based on the type of resource. In some embodiments, the virtualization client 406 may selectively alter or modify the delivery of only certain types of information (e.g., images). Images are used hereinafter as an example of the various dependent resources that can be efficiently downloaded to web browser 402 by the virtualization engine. Note that the examples of downloading images are selected for illustration purposes only; accordingly, the present application is not limited to these specific examples only.

In some other techniques, a compressed image is encoded in a format such that the image file is divided into a series of scans. The first scan shows the image at a lower quality, and the following scans gradually improve the image quality. For example, an image in progressive JPEG format is compressed in multiple passes of progressively higher detail. The initial passes include lower frequency components of the image, while the subsequent passes include higher frequency components of the image. Rendering an image in progressive JPEG format shows a reasonable preview of the image after a first pass of rendering of the lower frequency components of the image, with the image progressively turning sharper with higher detail after subsequent passes. A web browser can begin displaying an image encoded in progressive JPEG format as it is being downloaded from the network, by rendering each successive pass of the image as it is downloaded and received. Doing so improves on the start-up time experienced by the end-user. Nonetheless, upon a GET request for an image, the entirety of the image is downloaded. In some instances, components of the webpage other than the image may have higher priority than the details of the progressively encoded image contained in the subsequent passes, and it would be advantageous to download these important components of the webpage before the whole image. In some instances, it is preferable to deploy the bandwidth used to download the whole image than to instead download other important components of the webpage. However, such prioritization of webpage content is lost when the image is treated as a single binary content.

Therefore, in some embodiments, the startup wait time can be reduced by dividing a progressive JPEG image file (or other image files that are compressed in multiple passes of progressively higher detail) into a plurality of segments based on priorities, e.g., frequency. Having control of both ends of the communication in a client and server system, the lower frequency components of the image can be requested by client 406 and sent by edge server 408 first, and then the higher frequency components can be requested by client 406 and sent by server 408 dynamically to refresh and sharpen the image.

Since a webpage may include content retrieved by multiple GET requests, by dividing each GET request into a plurality of GET requests, the server transmit queue is reprioritized to transmit (and web browser 402 is reprioritized to render) the higher priority components of each of the GETs first. In particular, if one original GET request corresponds to a huge image, the impact of the huge image blocking all the other GET requests would be lessened. As a result, the latency of seeing the images from the other GET requests is reduced. The latency may be further reduced by obtaining the image components from one or more servers dynamically, the servers determined to be the most efficient/fastest using a content location address redirection at a user client that is already aware of the location address redirection mapping when the webpage is initially received.

In some embodiments, the segment sizes (e.g., the percentages of the original image file) delivered to web browser 402 in response to the plurality of GET requests may be tuned dynamically based on network load, network bandwidth, or other specifics of a user's connection. For example, the size of the first segment may be only 10% of the total image on a high latency and low bandwidth connection, while the size of the first segment may be 90% of the total image on a low latency and high bandwidth connection.

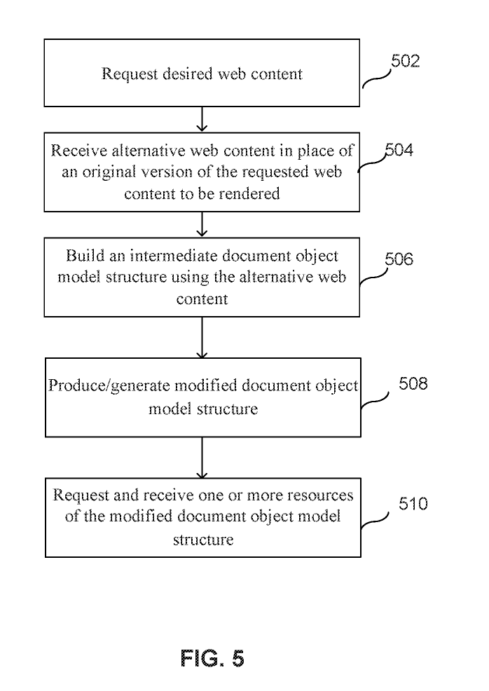

FIG. 5 is a flowchart illustrating an embodiment of a process for generating a modified document object model. The process of FIG. 5 may be implemented on client device 401, virtualization client 406, and/or web browser 402 of FIG. 4.

At 502, desired web content is requested. For example, a desired webpage is requested. In some embodiments, requesting the web content includes sending an HTTP request message to a server. Examples of the web content include a webpage, a streaming content, a web application, a web resource, a resource of a webpage, and any other content accessible via the Internet. For example, to display a web content (e.g., webpage 200 as shown in FIG. 2), web browser 402 sends an HTTP request message to a server (e.g., edge server 408 or content provider 412) requesting the HTML webpage file corresponding to the webpage. In some embodiments, the request includes an identifier of the requested content that is resolved to another identifier. For example, the request includes a URL (e.g., received from a user that types the URL or selects a link of the URL) and at least a portion of the URL is provided to a DNS server to translate at least a portion of the URL to an IP address to be utilized to request the web content. In some embodiments, the destination of the request is adjusted dynamically using the DNS server. For example, mapping between a domain of a URL of the request and an associated IP address may be modified to modify a destination of the request. In some embodiments, the requested web content is requested by an Adobe Flash application. In some embodiments, the requested web content is requested by a mobile application such as an Apple iOS application or a Google Android application.

At 504, alternative web content is received in place of an original version of the requested web content to be rendered. For example, the alternative web content is placeholder content that includes code for a virtualization client (e.g., virtualization client 406 of FIG. 4). In this example, by providing the virtualization client instead of the original requested web content, it enables the virtualization client to be implemented at a client device to subsequently request, intercept, and process the original requested web content to be rendered for optimizations before allowing the original requested web content to be rendered by a web browser. For example, in a traditional web content request response, the original requested web content to be rendered would be provided (e.g., obtained from an origin server or an edge server that cached the original requested web content) in response to the initial request in 502. However, by providing the alternative web content that will subsequently request the original version instead, a virtualization layer may be enabled in between a web browser and the original requested web content to enable optimizations.

In some embodiments, the received alternative web content includes a virtualization client such as virtualization client 406. For example, code for virtualization client 406 of FIG. 4 is inserted into a webpage file. In some embodiments, this webpage file is a placeholder webpage that does not include contents of the original requested webpage. In some embodiments, the webpage file includes a portion of the original requested webpage but not the entire contents of the original requested webpage file. The virtualization client may be coded in a managed programming language (e.g., runs in a Common Language Runtime) and/or a web programming/scripting language such as JavaScript, Java, .Net, etc. In some embodiments, the virtualization client may be injected by adding JavaScript client code in the head section of an HTML, webpage file included in the alternative web content. In some embodiments, the received alternative web content is received from edge server 408. In some embodiments, the received alternative web content is received directly from content provider 412.

In some embodiments, alternative web content includes an identification of the original requested web content to be rendered. In some embodiments, a location address where the original requested web content (e.g., URI where the actual original requested web content is located) is to be obtained is specified in the alternative web content. For example, rather than publishing web content to be accessible for rendering at a public location address to be utilized by a user to access the published web content, a content publisher publishes the web content at a different location address that will be instead accessed by a virtualization client included in the alternative content provided at the public location address of the original web content.

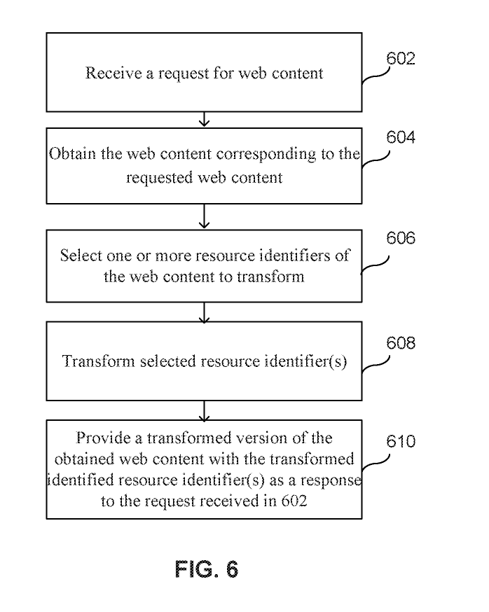

In some embodiments, the received alternative web content includes one or more resource identifiers that have been transformed using at least a portion of the process of FIG. 6.

At 506, an intermediate document object model (DOM) structure is built using the alternative web content. In some embodiments, building the intermediate document object model structure includes allowing a web browser (e.g., web browser 402 of FIG. 4) to receive and process the alternative web content received at 504. For example, the web browser builds a document object model tree of an alternative webpage received at 504. Building the intermediate document object model structure may include executing program code implementing a virtualization client (e.g., virtualization client 406 of FIG. 4) included in the received alternative web content. In some embodiments, building the intermediate document object model structure includes inserting objects in the intermediate document object model structure of content included in the alternative web content. For example, the alternative web content includes a portion of original requested web content to be rendered, and objects corresponding to the included original requested web content portions are inserted in the intermediate document object model structure.

At 508, a modified document object model structure is produced/generated. For example, the virtualization client included in the alternative web content modifies the intermediate document object model structure with data of the original requested web content to create a modified document object model structure. In some embodiments, generating the modified document object model structure includes requesting and receiving the original requested web content. For example, a virtualization client included in the received alternative content that was received in place of the original requested web content requests and receives the original requested web content to be rendered using an alternate location address where the original requested web content can be obtained. In some embodiments, a portion of the original requested web content was included in the received alternative content and a remaining portion of the original requested web content is requested by the virtualization client. In some embodiments, generating the modified document object model structure includes modifying the requested and received original requested web content. For example, location addresses specified in the original requested web content are modified. In another example, the original requested web content is modified for more optimized content delivery and/or rendering. In some embodiments, generating the modified document object model structure includes placing objects of the original requested web content in the intermediate document object model structure. For example, a virtualization client modifies the intermediate document object model structure to include objects of the original requested web content to render the original requested web content.

In some embodiments, generating the modified document object model structure includes modifying an original document object model structure corresponding to the original version of the desired web content. For example, objects of the original document object model structure are modified to generate the modified document object model structure. In some embodiments, generating the modified document object model structure includes placing objects of a modified version of the original requested web content in the intermediate document object model structure. The virtualization client may also manipulate the document object model tree of a web browser by making the appropriate method API calls to the DOM tree. As a result, the virtualization client may manipulate a DOM tree, including the creation, deletion, or update of nodes within the DOM tree. In some embodiments, generating the modified document object model structure includes modifying objects of the original requested web content before placing the modified objects in the intermediate document object model.

In various embodiments, by producing the modified document object model structure different from an original document object model structure corresponding to the original version of the desired web content, various types of different types of optimizations may be achieved. In some embodiments, content redirection can be achieved by replacing a location address of a webpage resource with another location address that is able to provide the resource faster. In some embodiments, optimized delivery of information over a network by segmentation and reprioritization of downloaded information can be achieved. For example, the delivery of the information (e.g., the order in which the information is delivered or the granularity of the information delivered) and the actual content of the delivered information corresponding to any nodes of the DOM tree may be altered, thereby speeding up the rendering of a webpage without compromising the end-user's experience.

In various embodiments, generating the modified document object model structure includes modifying the intermediate document object model structure (e.g., selecting a modification to be performed) based on a property of a client system (e.g., detected property) that is to render the original requested web content. For example, the optimizations of the original requested web content performed by the virtualization client take into consideration a property of the client system. For the same original requested web content, this may allow one type of optimization to be performed for one type of user system while allowing a different optimization to be performed for another type of user system. Examples of the property of the client system include the following: a type of web browser, a web browser version, available plugin/extensions of a web browser, a java processing software version, a type of operation system, a type of network connection, a network connection speed, a display property, a display type, a display window property, a type of user device, resources of a user system, or a system property of a user system.

In some embodiments, mapping data that is utilized by a virtualization client to modify the intermediate document object model structure is received. For example, the mapping data is utilized by the virtualization client to replace a content location address of a webpage resource to another address specified by the mapping data. The mapping data may include a data structure (e.g., a table, a database, a chart, a hash table, a list, a spreadsheet, etc.). In some embodiments, the received mapping data is encoded in HTML (e.g., encoded using HTML tags). In some embodiments, the received mapping data is encoded in JavaScript Object Notation. In some embodiments, by utilizing the mapping data, one or more content location addresses of the original requested web content may be dynamically modified. By modifying the content location address, referenced content may be replaced with different/modified content and/or provided from a different location. The received mapping data may include one or more entries mapping an initial location address to a translated location address. For example, a mapping data entry maps an initial URI/URL to a translated URI/URL. In another example, a mapping data entry maps an initial URI/URL to a location address that includes an IP address. The mapping data corresponds to the received original requested web content. For example, the received mapping data includes one or more entries that correspond to one or more location addresses referenced by the original requested web content. The mapping data may include an entry that maps a location address of a resource request to a translated location address. The initial location address of the original requested web content to be translated using the mapping data may be a dynamically generated location address. For example, the initial location address was generated from execution of a web application (e.g., programmed using a web programming language) of the received original requested web content.

In some embodiments, a location address of a network resource is used to search a data structure that includes the received mapping data. If an entry that matches the location address of the network resource is found, the location address of the network resource is modified using a corresponding translated location address specified by the matching entry. For example, the entry maps an initial URI/URL to a translated URI/URL and the matching initial URI/URL of the network resource is replaced with the translated URI/URL. In another example, a mapping data entry maps an initial URL to a location address that includes an IP address. If a matching entry is not found in the data structure, the initial location address without replacement or translation may be utilized. In some embodiments, if a matching entry is not found in the data structure, the initial location address is modified using a standard default translation. For example, a default translation policy specifies at least a portion of a location address (e.g., domain of the URI) to be replaced with another identifier.

In some embodiments, the mapping data is received together with the alternative web content as a single received content (e.g., specified in the alternative web content). In some embodiments, the alternative web content and the mapping data are received from the same server. In some embodiments, the mapping data is received together with the original requested web content. In some embodiments, the mapping data is received separately from the alternative web content and the original requested web content. For example, a virtualization client included in the web content requests/receives the mapping data in a separate request.

At 510, one or more resources of the modified document object model structure are requested and received. For example, a web browser traverses the modified DOM tree to retrieve any dependent resources (e.g., images, scripts, video, etc. to be obtained via a network to render a webpage) indicated by any of the nodes in the DOM tree via a network. In one example, the image object corresponding to the static image tag in webpage 200 redirects web browser 402 to fetch an image file from a URL. The received resources may be utilized to populate the modified DOM and/or provide/render content to a user. In some embodiments, the requests for the one or more resources are requested using corresponding network location addresses that have been modified/translated when modifying the intermediate DOM in 508. In some embodiments, requesting one or more resources includes intercepting a request for a resource. For example, a virtualization client such as virtualization client 406 intercepts requests for one or more resources of the web content before the request is made via the network.

A location address of the intercepted request may be replaced with a translated location address determined using the received mapping data. By using the translated location address, an initially referenced content may be replaced with a different/modified content and/or requested using a different server. In some embodiments, an inline code inserted in the received web content is utilized to intercept the request and/or replace the intercepted request with a translated location. In some embodiments, a programming language/script file inserted/referenced in the received web content (e.g., and provided with the received web content) is utilized to intercept the request and/or replace the intercepted request with a translated location. In some embodiments, a programming language/script code to be utilized to intercept the request and/or replace the intercepted request with a translated location is requested (e.g., requested using Ajax call or XMLHttpRequest call to a server such as edge server 408 of FIG. 4) and received. The received code may be encoded in a type of programming language/script based at least in part on a programming language/script that is to utilize the translated location. For example, the code to be utilized to intercept the request and/or replace the intercepted request with a translated location is encoded in a programming language/script that matches the programming language/script that will be using the translated location (e.g., JavaScript code provided for JavaScript application to utilize the translated location, ActionScript code provided for Flash application to utilize the translated location, native iOS code provided to an iOS application to utilize the translated location, etc.).

In some embodiments, once the location address of a resource has been analyzed and replaced with a translated location, if appropriate, the resource is requested via the network. Requesting the resource via the network may include further translating at least a portion of the translated location address using a name server (e.g., DNS server) to translate a domain name of the location address to an IP address.

In some embodiments, in response to a network resource request, an updated mapping data is received in addition to the requested resource content. For example, data updating the previously received mapping data is received along with the requested resource content if the mapping data is to be updated. In some embodiments, the updated mapping data includes a new mapping data to replace the entire previously received mapping data. For example, virtualization client 406 replaces a stored version of the previously received mapping data with the updated mapping data. In some embodiments, the updated mapping data includes only the data required to partially update the previously received mapping data. For example, virtualization client 406 utilizes the received update to modify a portion of the previously received mapping data.

The updated mapping data may be received from the same server as the server that provided the requested resource. In some embodiments, the updated mapping data is provided by a different server from the server that provided the requested resource content. The requested resource and the updated mapping data may be received together as a signal data package or may be received separately. In some embodiments, the updated mapping data is received as needed without necessarily being received in response to a resource request. For example, a virtualization client such as client 406 of FIG. 4 periodically polls a server (e.g., edge server 408 of FIG. 4) for any update to the mapping data. In another example, updates to the mapping data are dynamically provided/pushed to the virtualization client as needed.

FIG. 6 is a flowchart illustrating an embodiment of a process for providing a transformed version of a web content. The process of FIG. 6 may be implemented on edge server 408 and/or content provider 412 of FIG. 4. In some embodiments, the process of FIG. 6 is utilized to generate at least a portion of the alternative web content received in 504 of FIG. 5.

At 602, a request for web content is received. In some embodiments, the request is the request provided in 502 of FIG. 5. In some embodiments, the request is an intercepted request. For example, a web browser has requested a webpage using a URL that would traditionally map to content provided by an origin server (e.g., originally to be provided by content provider 412 of FIG. 4) and the request has been rerouted/forwarded to a different intermediary server (e.g., edge server 408 of FIG. 4). In one example, a client requested a webpage using a URL and a DNS mapping between a domain of the URL of the request and an associated IP address has been dynamically modified to redirect/modify a destination server of the request. Examples of the web content include a webpage, a web application, content of a mobile application, other networked content, etc.

At 604, the web content corresponding to the requested web content is obtained. For example, web content that would be traditionally provided from an origin content provider to a client has been intercepted and received at an intermediary server. In some embodiments, the web content is requested and obtained from a content provider (e.g., origin server) using a received identifier of the requested content of the request received in 602. In some embodiments, in the event the requested web content has been cached, a cached version is identified and obtained from the cache using an identifier of the requested content received in 602. In some embodiments, in the event the request has been directly received by an origin content provider, the requested content is identified and obtained from storage of the origin content provider.

At 606, one or more resource identifiers (e.g., identifier of dependent resources) of the web content to transform are selected. In some embodiments, identifier(s) of resource(s) known or vulnerable to be targeted by a third-party content modifier (e.g., content modifier 403 of FIG. 4) are selectively selected for transformation to prevent the third-party content modifier from recognizing the resource. For example, resources of one or more specified types (e.g., specific file type, script, advertisement, etc.) are selected for identifier transformation. In another example, resources to be obtained from one or more specified Internet domains (e.g., a portion of a URI of the resource matches) or servers are selected for identifier transformation. In some embodiments, one or more identifiers of resource(s) known to be not targeted by a third-party content modifier are also selected for transformation. For example, once third-party content modifiers realize that targeted resource identifiers are to be obfuscated, a third-party content modifier may recognize a pattern of the transformations and block all resources that are identified by transformed/obfuscated identifiers. By also transforming identifiers of resources that the third-party content modifier does not desire to modify/block, the third-party content modifier is unable to simply block/modify all requests for resources with transformed/obfuscated identifiers and is also unable to take a whitelist approach of only allowing requests for resources with known/recognized identifiers. In some embodiments, all resource identifiers of the web content are transformed. Examples of resources include a file, an image, a script, a JavaScript, a script element, a web program, a style sheet language object (e.g., CSS file), and other content elements to be obtained to render the web content. Examples of resource identifiers include at least a portion of a name, a filename, a variable name, a URI, or other identifier. In some embodiments, the selected resource identifiers are static resource identifiers of the received web content.

At 608, selected resource identifier(s) are transformed. For example, transforming a resource identifier includes modifying a name of the resource. The resource identifier may be included in a URI. In some embodiments, transforming a resource identifier includes encrypting at least a portion of the resource identifier. For example, the resource identifier is encrypted using a public key of a public key cryptography that can be only decrypted using a private key corresponding to the public key. In some embodiments, the key utilized to encrypt the resource identifier is specific to a content provider of the resource, a recipient (e.g., client) of the resource, an intermediary server performing the encryption, a resource type, and/or a network/Internet domain/URI of the resource. In some embodiments, the key utilized to encrypt the resource identifier is common across various different content providers, recipients (e.g., clients), intermediary servers performing the encryption, resource types, and/or network/Internet domains/URIs. In some embodiments, the key utilized to encrypt the resource identifier is automatically changed over time. For example, in order to prevent a third-party content modifier from learning a pattern of the encryption, the encryption key is changed periodically. In some embodiments, transforming the resource identifier includes hashing at least a portion of the resource identifier. For example, a hash value is determined as the transformed identifier using a hashing function and the original resource identifier is stored in a corresponding hash table. In some embodiments, the original resource identifier is stored in a table, a database, or other data structure to be utilized to determine the original resource identifier from the transformed identifier.

At 610, a transformed version of the obtained web content with the transformed identified resource identifier(s) is provided as a response to the request received in 602. In some embodiments, the transformed version of the web content has been generated by replacing the selected resource identifiers with the corresponding translated resource identifiers. In some embodiments, the provided web content is received at 504 of FIG. 5. In some embodiments, the transformed version includes a virtualization client (e.g., virtualization client 406 of FIG. 4). For example, the virtualization client has been configured to operate on the transformed resource identifiers to allow the transformed resource identifiers to be utilized to request, obtain, and process the corresponding resources using the transformed identifiers rather than the original resource identifiers.

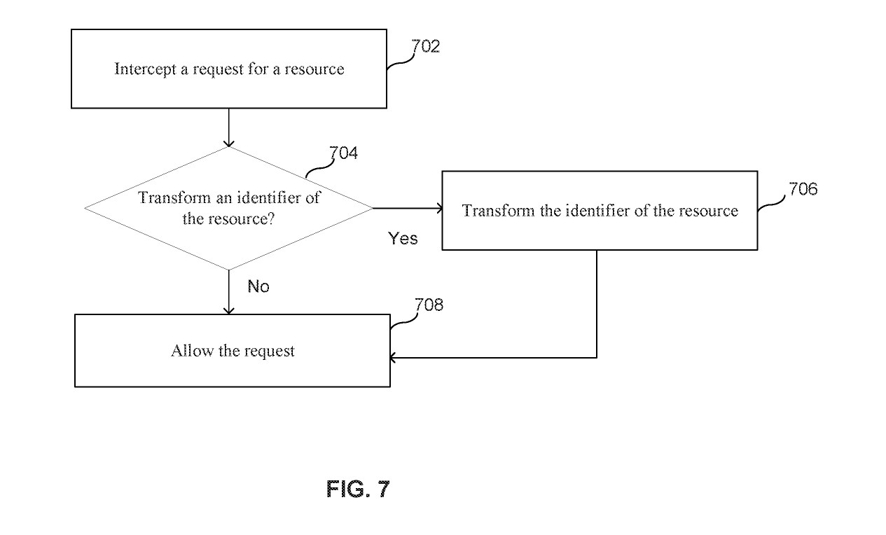

FIG. 7 is a flowchart illustrating an embodiment of a process for dynamically transforming a resource identifier. The process of FIG. 7 may be implemented on client 401 of FIG. 4. For example, at least a portion of the process of FIG. 7 is implemented using virtualization client 406 and/or web browser 402 of FIG. 4. In some embodiments, the process of FIG. 7 is repeated for each intercepted request for a resource of a plurality of dependent resources of a web content.

At 702, a request for a resource is intercepted. In some embodiments, the request is a request for an external dependent resource of web content (e.g., webpage) received in 504 of FIG. 5. Examples of resources include a file, an image, a script, a JavaScript, a script element, a web program, a style sheet language object (e.g., CSS file), and other content elements to be obtained to render the web content. In some embodiments, the interception of the request for the resource is performed by a virtualization client (e.g., virtualization client 406 of FIG. 4). For example, the virtualization client is a JavaScript program that has been inserted into a webpage that intercepts requests for a dependent resource of a webpage. The virtualization client may have been inserted in the webpage in 610 of FIG. 6 that is received in 504 of FIG. 5. In some embodiments, the interception of the request is performed prior to when a third-party content modifier (e.g., third-party content modifier 403 of FIG. 4) has access to the request. In some embodiments, intercepting the request includes identifying a resource to be obtained in the modified document object in 508 of FIG. 5. In some embodiments, the intercepted request is a dynamically generated request (e.g., request generated using a script).

At 704, it is determined whether to transform an identifier of the resource. In some embodiments, the identifier of the resource is to be transformed if the resource is known or vulnerable to be targeted by a third-party content modifier. The identifier of the resource is then selected for transformation to prevent the third-party content modifier from recognizing the resource. For example, resources of one or more specified types (e.g., specific file type, script, advertisement, etc.) are selected for identifier transformation. In another example, resources to be obtained from one or more specified Internet domains (e.g., a portion of a URI of the resource matches) or servers are selected for identifier transformation. In some embodiments, the identifier of the resource is to be transformed even if the resource is known to be not vulnerable or not targeted by a third-party content modifier. For example, by also transforming identifiers of resources that the third-party content modifier does not desire to modify/block, the third-party content modifier is unable to simply block/modify all requests for resources with transformed/obfuscated identifiers and is also unable to take a whitelist approach of only allowing requests for resources with known/recognized identifiers. In some embodiments, it is determined to not transform the identifier of the resource if the identifier has been already transformed (e.g., transformed in 608 of FIG. 6). In some embodiments, every resource identifier of a web content is to be transformed if it has not been already transformed. Examples of the identifier include at least a portion of a name, a filename, a variable name, a URI, or other identifier.

If at 704 it is determined that the identifier of the resource is to be transformed, at 706, the identifier of the resource is transformed. For example, transforming the resource identifier includes modifying a name of the resource. In some embodiments, transforming a resource identifier includes encrypting at least a portion of the resource identifier. For example, the resource identifier is encrypted using a public key of a public key cryptography that can be only decrypted using a private key corresponding to the public key. In some embodiments, the key utilized to encrypt the resource identifier is specific to a content provider of the resource, a recipient (e.g., client) of the resource, an intermediary server performing the encryption, a resource type, and/or a network/Internet domain/URI of the resource. In some embodiments, the key utilized to encrypt the resource identifier is common across various different content providers, recipients (e.g., clients), intermediary servers performing the encryption, resource types, and/or network/Internet domains/URIs. In some embodiments, the key utilized to encrypt the resource identifier is automatically changed over time. For example, in order to prevent a third-party content modifier from learning a pattern of the encryption, the encryption key is changed periodically. A new encryption key (e.g., public key) may be received or obtained from a server periodically. In some embodiments, transforming the resource identifier includes hashing at least a portion of the resource identifier. For example, a hash value is determined as the transformed identifier using a hashing function and the original resource identifier is stored in a corresponding hash table. In some embodiments, the original resource identifier is stored in a table, a database, or other data structure to be utilized to determine the original resource identifier from the transformed identifier. In some embodiments, transforming the identifier of the resource includes modifying a DOM of a webpage that referenced the resource to include the transformed identifier. For example, at 508 of FIG. 5, the content location address of the resource is modified in the DOM of the webpage.

At 708, the request is allowed. For example, the received request is allowed to be made using the transformed identifier of the resource. In some embodiments, the request may identify the requested resource by its translated identifier that was translated in 608 of FIG. 6 or in 706 of FIG. 7. In some embodiments, allowing the request includes sending the request for the resource via a network to an intermediary server (e.g., edge server 408 of FIG. 4) or directly to a content provider (e.g., content provider 412 of FIG. 4) to allow a transformed identifier of the resource to be translated back to its original identifier for identification and retrieval of the resource. In some embodiments, allowing the request includes allowing the resource of a modified document object model structure to be requested and received in 510 of FIG. 5. In some embodiments, in the event the requested resource has been locally cached, the requested resource is obtained locally (e.g., from cache 410 of FIG. 4).

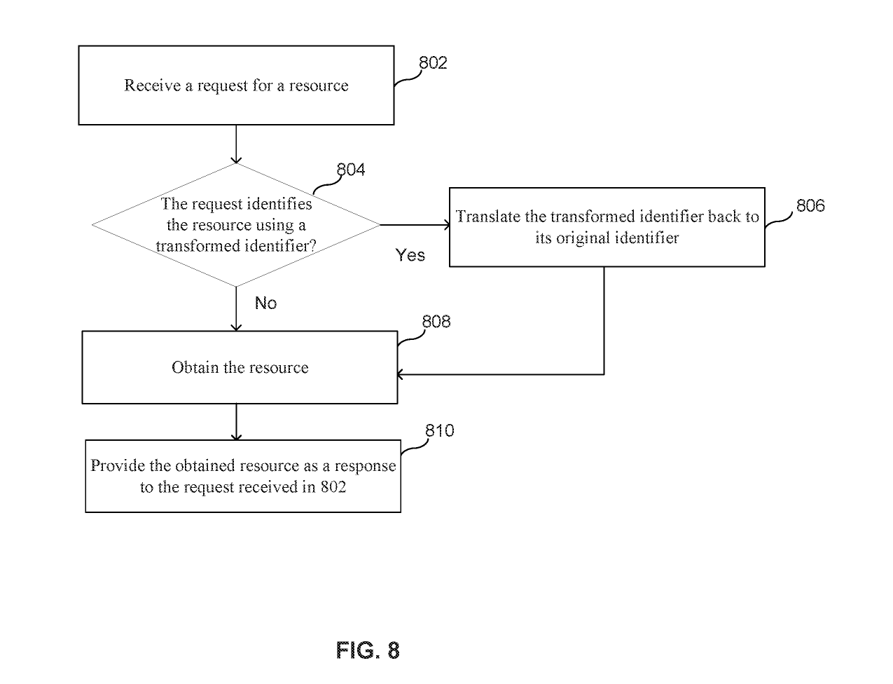

FIG. 8 is a flowchart illustrating an embodiment of a process for providing a resource in response to a request. The process of FIG. 6 may be implemented on edge server 408 and/or content provider 412 of FIG. 4.

At 802, a request for a resource is received. In some embodiments, the received request is the request provided in 510 of FIG. 5 or 708 of FIG. 7. For example, the requested resource is a dependent resource of a webpage.

At 804, it is determined whether the request identifies the resource using a transformed identifier. For example, it is determined whether the identifier of the resource included in the request is an encrypted, hashed, or otherwise obfuscated/protected identifier.

If at 804 it is determined that the request identifies the resource using a transformed identifier, at 806 the transformed identifier is translated back to its original identifier. In some embodiments, translating the transformed identifier includes decrypting at least a portion of the transformed identifier. For example, the transformed resource identifier has been encrypted using a public key of a public key cryptography and is decrypted using a private key corresponding to the public key. In some embodiments, the key utilized to decrypt the resource identifier is specific to a content provider of the resource, a recipient (e.g., client) of the resource, an intermediary server performing the encryption, a resource type, and/or a network/Internet domain/URI of the resource. In some embodiments, the key utilized to decrypt the resource identifier is common across various different content providers, recipients (e.g., clients), intermediary servers performing the encryption, resource types, and/or network/Internet domains/URIs. In some embodiments, the key utilized to decrypt the resource identifier is automatically changed over time to correspond to the change in the encryption key. In some embodiments, translating the resource identifier includes using at least a portion of the transformed identifier as the hash value and obtaining the original identifier from a hash table. In some embodiments, the original resource identifier has been stored in a table, a database, or other data structure to be utilized to determine the original resource identifier from the transformed identifier. For example, at least a portion of the transformed identifier is utilized to perform a lookup of the data structure to find an entry storing the original identifier.

At 808, the resource is obtained. In some embodiments, the resource is obtained using the original identifier determined in 806. The resource may be obtained from a cache of an intermediary server. In some embodiments, the resource is obtained by requesting and receiving the resource via a network from a content server (e.g., from content provider 412) using a URI that includes the determined original identifier.

At 810, the obtained resource is provided as a response to the request received in 802. In some embodiments, the provided response of 810 is received in 510 of FIG. 5.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for protecting content, comprising:
a communication interface configured to receive a request for a resource of web content; and
a processor coupled with the communication interface and configured to:
determine whether the request identifies the resource using a transformed identifier that has been generated by transforming an original identifier of the resource;
in the event it is determined that the request identifies the resource using the transformed identifier, translate the transformed identifier back to the original identifier of the resource;
obtain the resource using the original identifier of the resource; and
provide the obtained resource as a response to the request for the resource of web content.

2. The system of claim 1, wherein the transformed identifier was transformed to obfuscate is an identity of the resource.

3. The system of claim 1, wherein the transformed identifier was transformed by encrypting at least a portion of the original identifier.

4. The system of claim 1, wherein the transformed identifier was transformed by hashing at least a portion of the original identifier using a hash function.

5. The system of claim 1, wherein translating the transformed identifier includes decrypting at least a portion of the transformed identifier.

6. The system of claim 1, wherein the web content includes a virtualization client that intercepted the request and transformed the original identifier to the transformed identifier.

7. The system of claim 1, wherein the web content included the transformed identifier prior to delivery of the web content to a web browser.

8. The system of claim 1, wherein the transformed identifier was generated in response to a determination that a third-party content modifier was operating.

9. The system of claim 1, wherein the transformed identifier was generated in response to a determination that a content modifying web browser plugin was installed on a client.

10. The system of claim 1, wherein the original identifier was specifically identified for transformation to the transformed identifier in response to a determination that the resource was an advertisement.

11. The system of claim 1, wherein the web content has been configured to request every external dependent resource of the web content using a corresponding transformed identifier of each external dependent resource.

12. The system of claim 1, wherein obtaining the resource using the original identifier of the to resource includes requesting the resource using a URI generated using the original identifier.

13. The system of claim 1, wherein the web content includes a webpage.

14. The system of claim 1, wherein the resource is a file referenced by the web content to be obtained to render the web content.

15. The system of claim 1, wherein the transformed identifier was generated by modifying is the original identifier.

16. The system of claim 1, wherein the transformed identifier is included in a URI.

17. A method for protecting content, comprising:
receiving a request for a resource of web content;
determining whether the request identifies the resource using a transformed identifier that has been generated by transforming an original identifier of the resource;
in the event it is determined that the request identifies the resource using the transformed identifier, using a processor to translate the transformed identifier back to the original identifier of the resource;
obtaining the resource using the original identifier of the resource; and
providing the obtained resource as a response to the request for the resource of web content.

18. A system for protecting content, comprising:
a processor configured to:
intercept a request for a resource of web content prior to detection of the request by a third-party content modifier;
transform an original resource identifier of the resource to a transformed resource identifier; and
allow the request, wherein the request identifies the resource using the transformed resource identifier and allowing the request includes providing the request to a server having a process that is configured to operate on the transformed resource identifier; and
a network communication interface coupled with the processor and configured to transmit the request via a network.

19. The system of claim 18, wherein a virtualization client inserted in the web content as a script intercepts the request.

20. The system of claim 18, wherein the third-party content modifier is configured to block the request in the event the request identifies the resource using the original resource identifier.
